(19) United States
(12) Patent Application Publication
(10) Pub. No.: US 2021/0150308 A1
(43) Pub. Date: May 20, 2021

(54) Artificial Intelligence Engine

(71) Applicant: Chaoyang Semiconductor Jiangyin Technology CO. LTD., San Diego, CA (US)

(72) Inventor: Saeid Safavi, San Diego, CA (US)

(21) Appl. No.: 17/098,371

(22) Filed: Nov. 14, 2020

Related U.S. Application Data
(60) Provisional application No. 62/935,592, filed on Nov. 14, 2019.

(51) Int. Cl. G06N 3/04; G06N 3/06

(52) U.S. Cl. CPC G06N 3/04; G06N 3/06

(57) ABSTRACT

A plurality of microphones are coupled to an audio feature extractor (AFE). The output of the AFE is coupled to a local Artificial Intelligence (AI) platform. Additional feature extraction and classification is performed by the platform. Event Descriptors (Eds) are output from the platform and coupled to amplifiers that amplify the EDs to provide audio output from speakers, headsets, etc. In addition, the EDs are provided to a set of devices, such as internet of things (IOT) devices and cloud devices. Still further the EDs can be provided as control signals to devices. A high dynamic range AFE is provided. In addition, a reconfigurable AI platform is provided. Still further, the AI form factor is extremely small.

### CROSS-REFERENCE TO RELATED APPLICATIONS—CLAIM OF PRIORITY

The present application claims priority to U.S. Provisional Application No. 62/935,592, filed Nov. 14, 2019, entitled “Artificial Intelligence”, which is herein incorporated by reference in its entirety.

### BACKGROUND

### (1) Technical Field

This invention relates to electronic circuits, and more particularly to circuits for implementing artificial intelligence engines.

### (2) Background

It is becoming more common today for Artificial Intelligence (AI) engines to be used to solve a plethora of complex problems. In particular, AI engines are currently being used more widely accepted as an appropriate part of the solution to the problem of identifying patterns and to classifying data into groups and detecting the presence of a particular feature within a data set.

For example, AI engines are being used to assist in identifying particular audio features that can then, in turn, assist with identifying the conditions present in a particular environment. More particularly, sounds that can be captured and analyzed can provide significant information about the status of an environment in which the sounds were captured. Therefore, there is an interest in providing the most efficient and effective AI engine for classifying and identifying particular features in an audio file. Improvements in such AI engines may also be of significant value for solving other problems for which AI engines are being employed.

Accordingly, there is a need for an improved AI engine that reduces power consumption and size and that can accurately identify audio features within an audio data file.

### DESCRIPTION OF THE DRAWINGS

FIG. 1 is an illustration of the general context of the presently disclosed method and apparatus.

FIGS. 2 and 3 provide additional context for the disclosed method and apparatus.

FIG. 4 shows the improvements in performance that are achieved by the presently disclosed method and apparatus.

FIG. 5 is an illustration of the mapping of the input features to the first set of nodes within the network.

FIG. 6 shows some of the performance parameters and the improvements possible.

FIG. 7 illustrates an embodiment in which the input features are mapped as noted in FIG. 5, but with the input receive nodes coupled to a fully connected neural network.

FIG. 8 shows another architecture in accordance with one embodiment of the disclosed method and apparatus.

FIG. 9 provides some parameters related to the implementation of the disclosed method and apparatus.

FIGS. 10 through 14 are yet other embodiments of the disclosed method.

Like reference numbers and designations in the various drawings indicate like elements.

### SUMMARY

A plurality of microphones are coupled to an audio feature extractor (AFE). The output of the AFE is coupled to a local Artificial Intelligence (AI) platform. Additional feature extraction and classification is performed by the platform. Event Descriptors (Eds) are output from the platform and coupled to amplifiers that amplify the EDs to provide audio output from speakers, headsets, etc. In addition, the EDs are provided to a set of devices, such as internet of things (IOT) devices and cloud devices. Still further the EDs can be provided as control signals to devices such as cameras, smart locks and lights, etc. In some embodiments, a very high dynamic range AFE enables an AI engine within the platform to detect a wide range of acoustic events. In addition, in some embodiments, a reconfigurable AI platform allows the apparatus to serve various verticals with the same hardware. Still further, in some embodiments, the AI form factor is extremely small with millisecond latencies.

### DETAILED DESCRIPTION

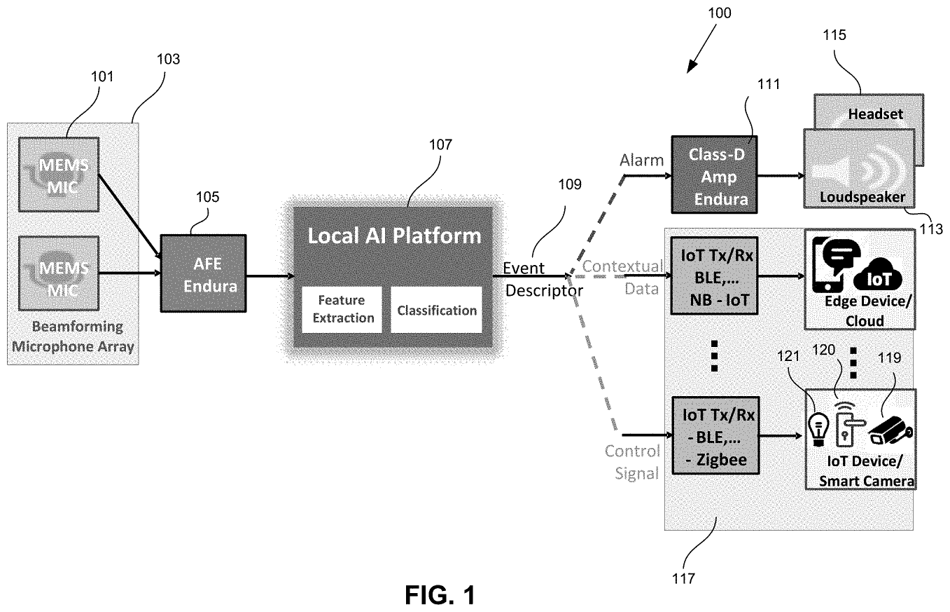

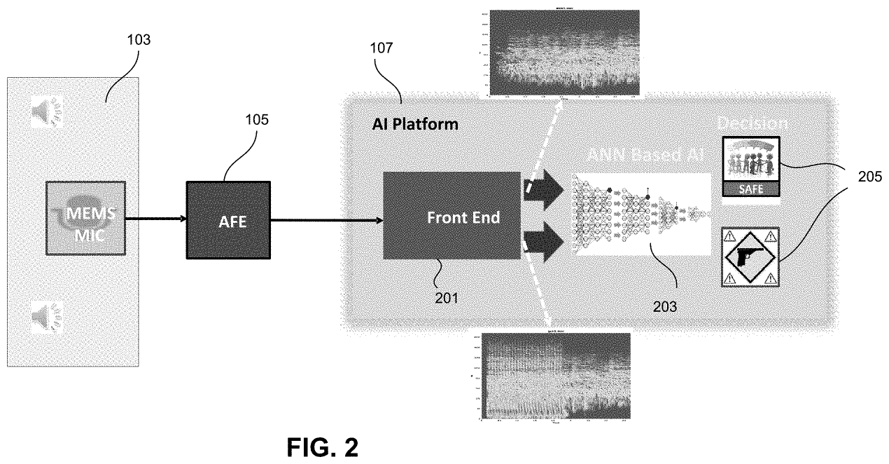

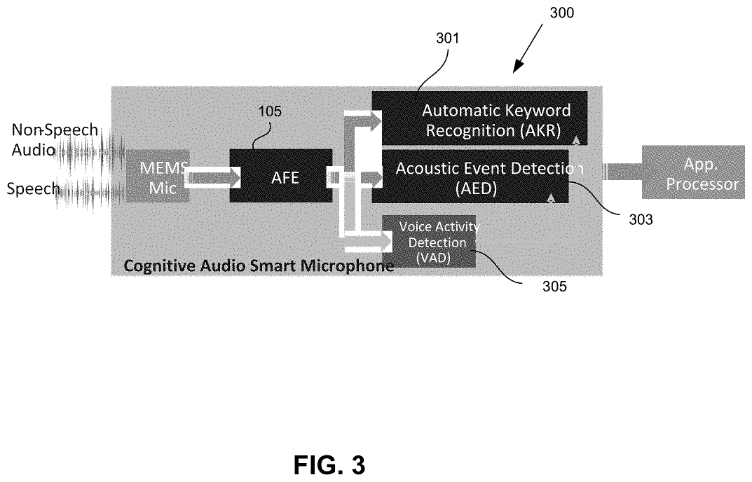

FIG. 1 is an illustration of the general context of the presently disclosed method and apparatus 100. A plurality of microphones 101, which in some embodiments form a beamforming array 103, are coupled to an audio feature extractor (AFE) 105. The output of the AFE 105 is coupled to a local Artificial Intelligence (AI) platform 107. Additional feature extraction and classification is performed by the platform 107. Event Descriptors (Eds) 109 are output from the platform 107 and coupled to amplifiers 111 that amplify the EDs 109 to provide audio output from speakers 113, headsets 115, etc. In addition, the EDs 109 are provided to a set of devices 117, such as internet of things (IOT) devices and cloud devices. Still further the EDs 109 can be provided as control signals to devices such as cameras 119, smart locks 120 and lights 121, etc. In some embodiments, a very high dynamic range AFE enables an AI engine within the platform 107 to detect a wide range of acoustic events. In addition, in some embodiments, a reconfigurable AI platform 107 allows the apparatus 100 to serve various verticals with the same hardware. Still further, in some embodiments, the AI form factor is extremely small with millisecond latencies. FIG. 2 and FIG. 3 provide additional context for the disclosed method and apparatus.

FIG. 2 shows an AI platform 107, such as the platform 107 of FIG. 1. In the example shown in FIG. 2, a front end 201 provides an interface for receiving and doing an initial processing of signals received from the AFE 105, such as filtering, amplification and initial feature extraction. An artificial neural network (ANN) based AI engine 203 provides the means by which decisions 205 can be made as to whether the sounds that are detected by the microphone array 103 constitute a particular pattern that matches a particular type of event, such as a gunshot or distress cries from a person experiencing difficulty of some sort.

FIG. 3 shows a cognitive audio smart microphone CASM 300 in accordance with one embodiment in which a microphone 301 provides an audio output to an AFE 303. The AFE 303 in turn provides an output to an automatic keyword recognition (AKR) module 305, an acoustic event detection (AED) module 307 and a voice activity detection (VAD) module 309. The VAD module 309 provides triggers to the AKR module 305 and the AED module 307 to allow these modules to operate in a low power consumption mode until activity is detected. The CASM 300 can be configured to allow tagging of up to 5 audio events, one event at a time. In addition, in some embodiments, the CASM 300 can be reconfigured to allow selected keywords and commands to be recognized. In some embodiment, the CASM 300 can recognize up to 5 commands. The configuration in which intelligence is provided directly at the microphone allows the system to operate with orders of magnitude more power efficiency than comparable state of the art edge AI systems by using local keyword and command recognition. In some embodiments, the CASM 300 has an ultra-low power “always on” VAD 305. In some such embodiments, the VAD 305 draws 45 microwatts and has a form factor on the order of 0.25 mm².

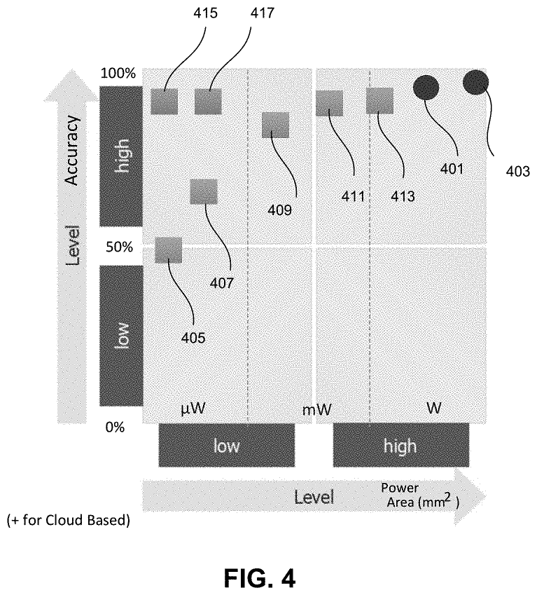

FIG. 4 shows the improvements in performance that are achieved by the presently disclosed method and apparatus. A first set of points 401, 403 show the relative accuracy and power for an existing cloud computing technology in which software based architectures are run on CPUs/GPUs with very large DNN architectures. These systems have a relatively high/moderate power consumption. A second set of points 405, 407, 409, 411, 413 show the relative accuracy and power consumption for existing edge computing technology in which software and hardware based architectures run on low power hardware (DSP, CPU, GPU) and highly optimized DNN architectures are used. These systems have moderate power consumption. It can be seen that these systems operate at lower power, but with lower accuracy as well. Lastly, the two points 415, 417 show the relatively high accuracy achieved with relatively low power consumption with the architecture of the disclosed method and apparatus.

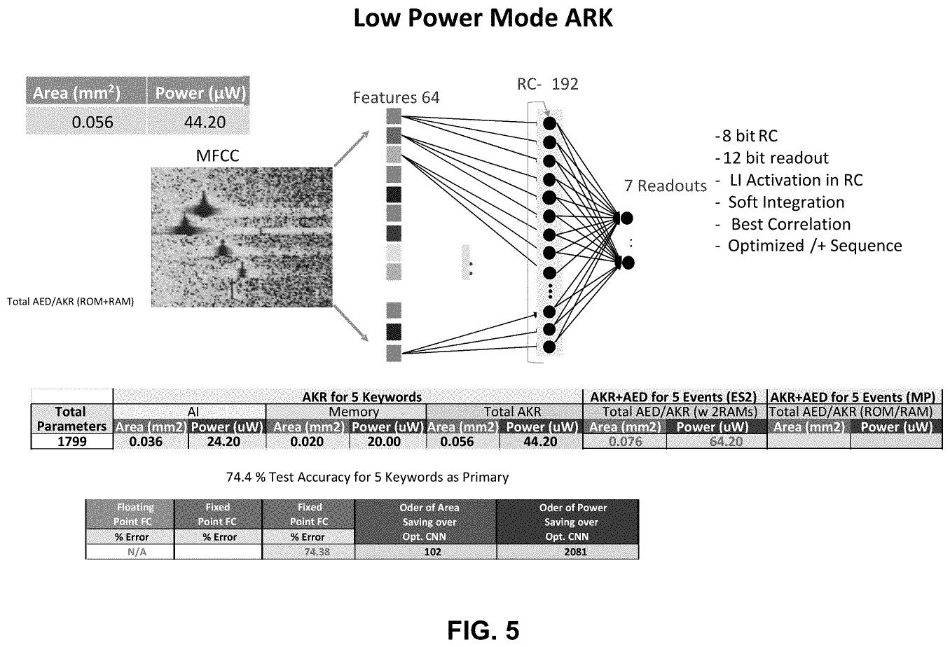

FIG. 5 is an illustration of the mapping of the input features to the first set of nodes within the network. In the example shown, 64 features are mapped at the input of the network into 192 receive nodes. Each input feature is mapped to three consecutive receive nodes of the 192. Since there are three times as many receive nodes as input features, the mapping allows a three to one map of features to receiving nodes. This particular mapping is favorable and provides advantages in the processing of the features.

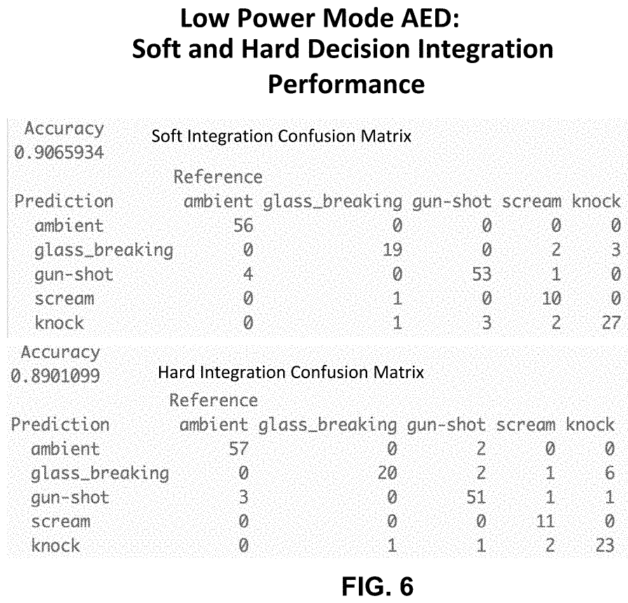

FIG. 6 shows some of the performance parameters and the improvements possible.

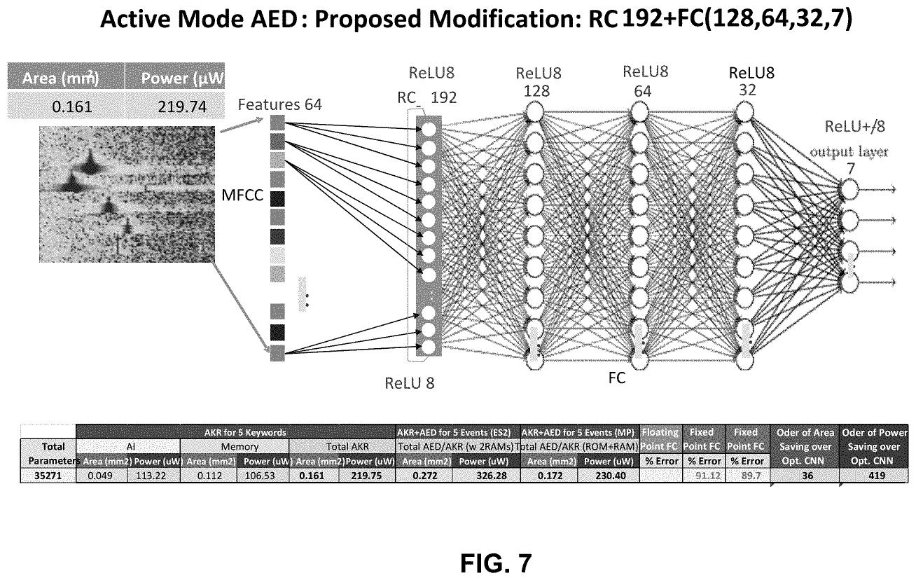

FIG. 7 illustrates an embodiment in which the input features are mapped as noted in FIG. 5, but with the input receive nodes coupled to a fully connected neural network.

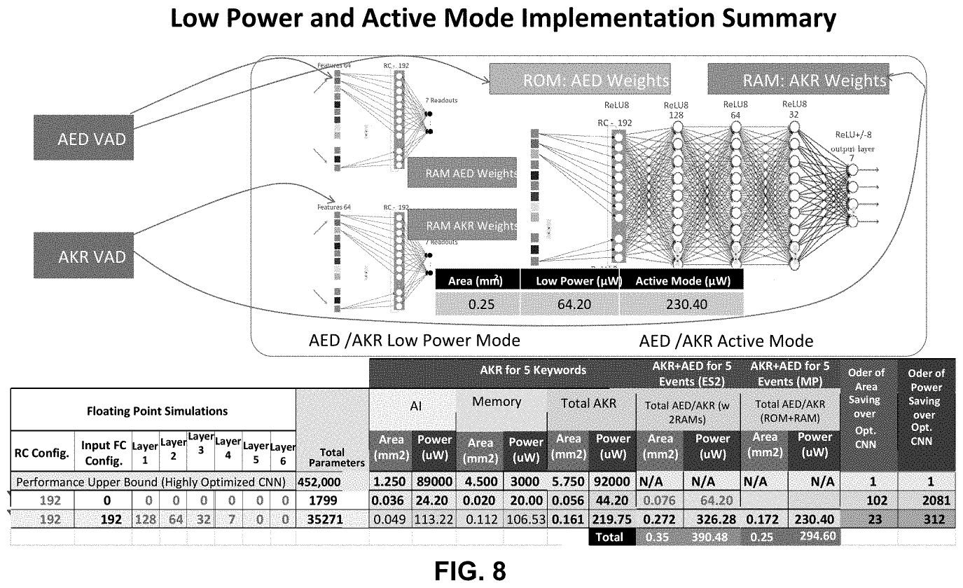

FIG. 8 shows another architecture in accordance with one embodiment of the disclosed method and apparatus.

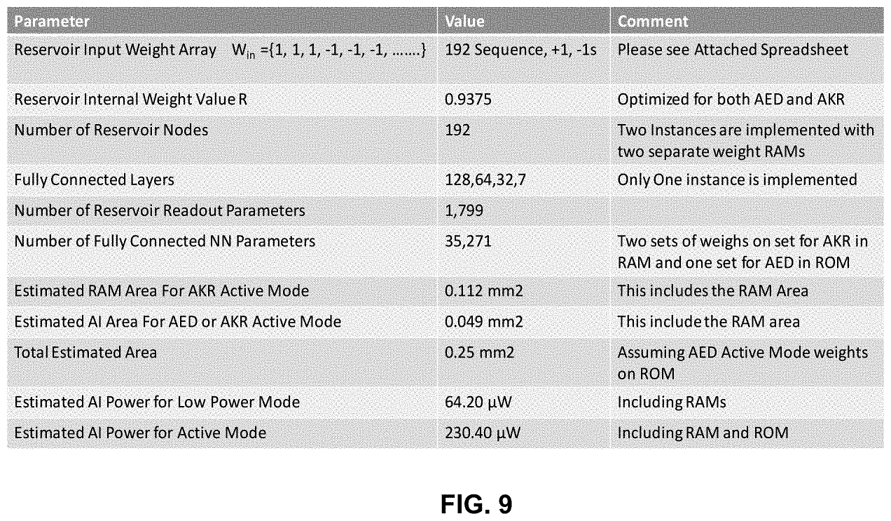

FIG. 9 provides some parameters related to the implementation of the disclosed method and apparatus.

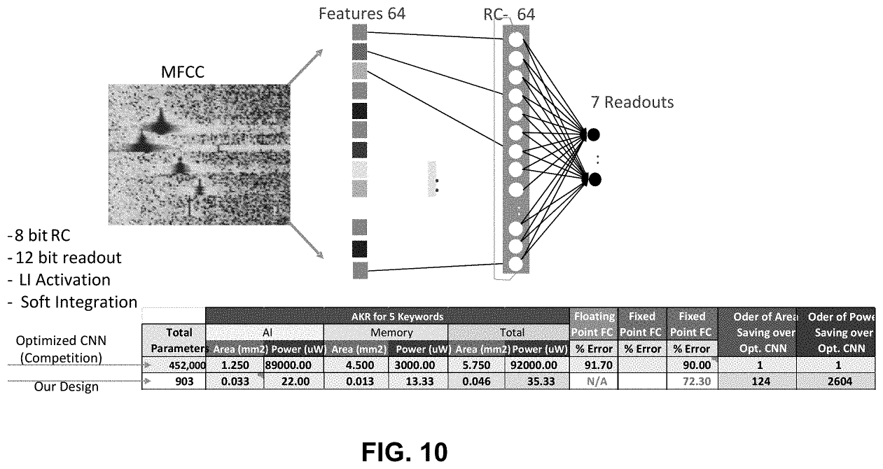

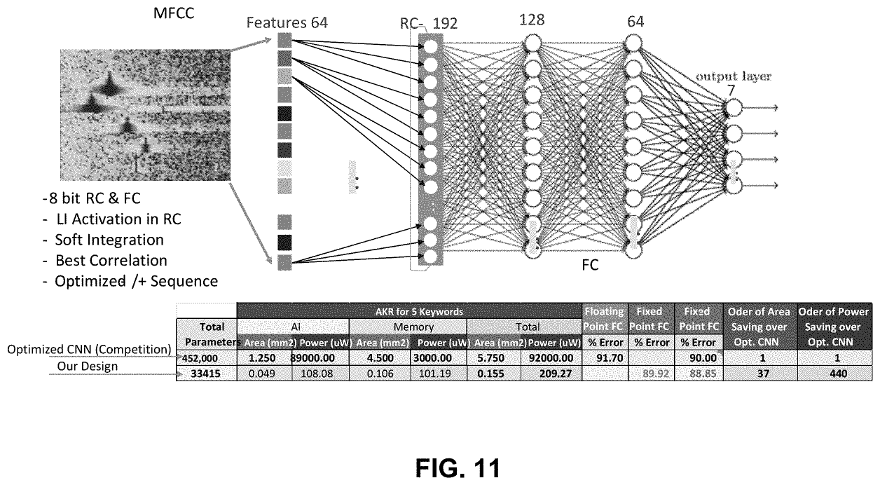

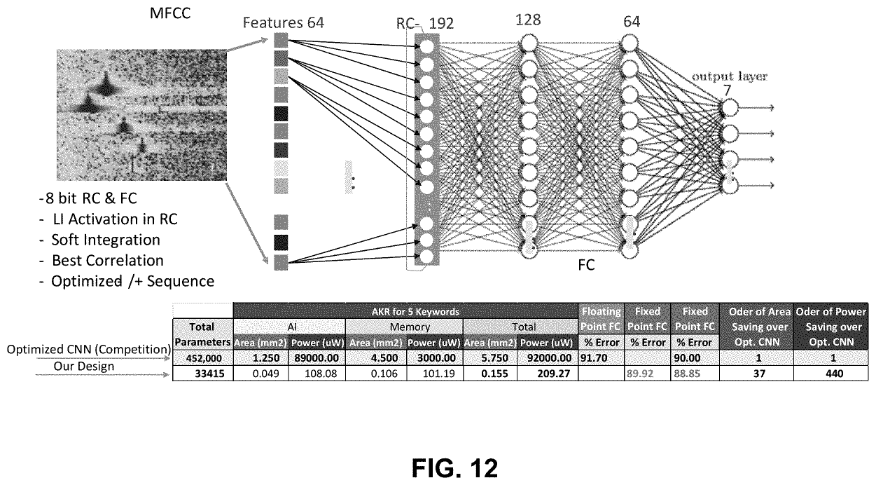

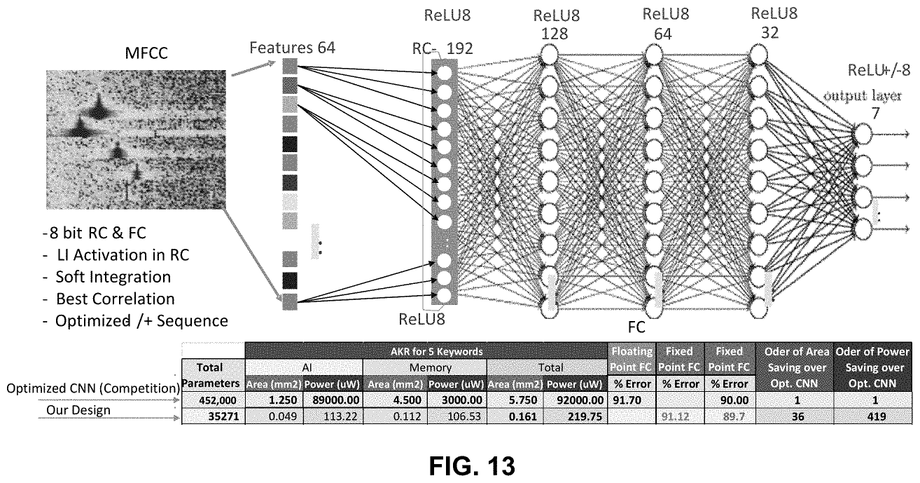

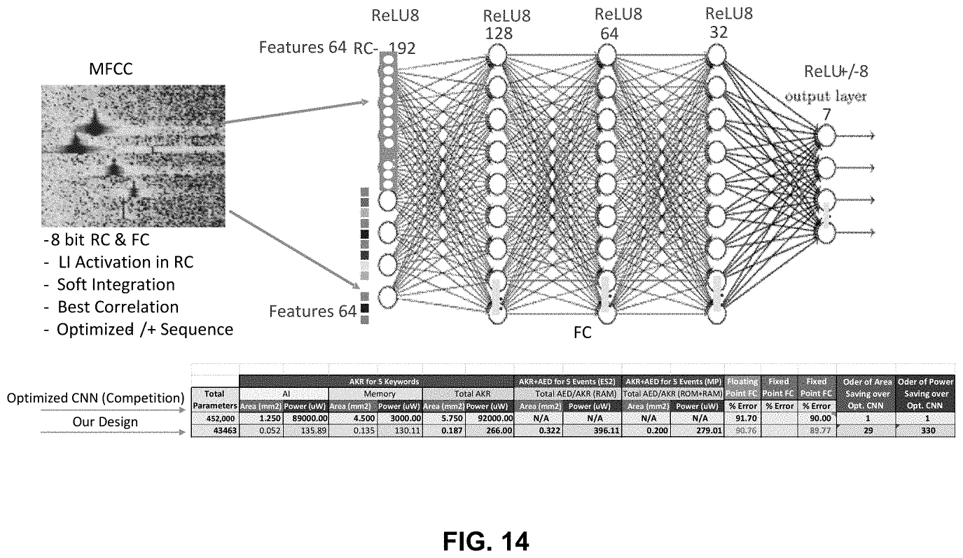

FIGS. 10 through 14 are yet other embodiments of the disclosed method.

In accordance with some embodiments of the disclosed method and apparatus, two separate circuitries are provided for VAD activate AKR or AED (one at a time). In addition, Leaky Integrator Implementation for all Reservoir Nodes (Both RC and RC-FC architectures) are provided. An integrated Single RC-FC architecture is provided for AKR and AED both as part of “Active Mode”. The goal is to use RAM for AKR and ROM for AED weights in the production phase. For ES2, two separate RAMs are used in some embodiments. Two RCs are integrated for AKR and AED within the “Low Power Mode”. Both Hard Integration and Soft Integration are implemented and are mode selectable by a control signal. Two median filtering mechanisms are implemented, one per each integration method. A control signal mechanism is allocated to bypass or include “Median Filtering”. Optimized Wᵢₙ Sign Sequence is implemented. RC-FC Architectures use ReLU 8 for Reservoir readout and all hidden layers and ReLU −/+8 for the last layer. RC architectures use a linear readout.

In various embodiments, one or more of the above methods may include, without limitation, one or more of the following characteristics and/or additional elements: wherein the different impedance at the internal node is higher than the input impedance; wherein the different impedance at the internal node is lower than the input impedance; wherein the power clamping circuit is a diode-based clamping circuit; wherein the power clamping circuit is a diode-connected MOSFET-based clamping circuit; wherein the impedance transform circuit is a variable impedance transform circuit; wherein the impedance transform circuit is one of a series type impedance transform circuit, or a shunt type impedance transform circuit, or a series-shunt type impedance transform circuit; wherein the impedance transform circuit includes at least one variable inductance and/or capacitance; further including selectively coupling the power clamping circuit to the internal node of the impedance transform circuit.

Circuits and devices in accordance with the present invention may be used alone or in combination with other components, circuits, and devices. Embodiments of the disclosed method and apparatus may be fabricated in whole or in party as integrated circuits (ICs), which may be encased in IC packages and/or or modules for ease of handling, manufacture, and/or improved performance.

As should be readily apparent to one of ordinary skill in the art, various embodiments of the invention can be implemented to meet a wide variety of specifications. The inductors and/or capacitors in the various embodiments may be fabricated on an IC “chip”, or external to such a chip and coupled to the chip in known fashion. The values for the inductors and capacitors generally will be determined by the specifications for a particular application, taking into account such factors as RF frequency bands, the natural limiting voltage of the clamping circuit, system requirements for saturated output power and expected level of large input signals, etc.

### CONCLUSION

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion.

It is to be understood that the foregoing description is intended to illustrate and not to limit the scope of the invention, which is defined by the scope of the following claims, and that other embodiments are within the scope of the claims. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. An Artificial Intelligence Network architecture including:
(a) a first set of input nodes configured to receive a set of features; and
(b) a set of receive nodes coupled to the first set of input nodes in accordance with a one to three mapping.
